(19) United States
(12) Patent Application Publication
(10) Pub. No.: US 2003/0226585 A1
(43) Pub. Date: Dec. 11, 2003

(54) Walker mocs

(76) Inventor: Dan Greg Burchel, Enid, OK (US)

Correspondence Address: Dan Burchel, Rt # 2, Box 456, Enid, OK, 73703, US

(21) Appl. No.: 10/162,720

(22) Filed: Jun. 6, 2002

(51) Int. Cl. A61H 3/02; A45B 9/04

(52) U.S. Cl. 135/77

(57) ABSTRACT

The Walker Moc invention is an effective and durable walker gliding system that utilizes a special design & fastening of leather. This leather gliding surface will provide smooth and efficient rolling walker propulsion over all indoor & outdoor surfaces. Walker Mocs protect all flooring surfaces and greatly outlast the commonly adapted tennis ball. Walker Mocs are easily applied & are maintenance free.

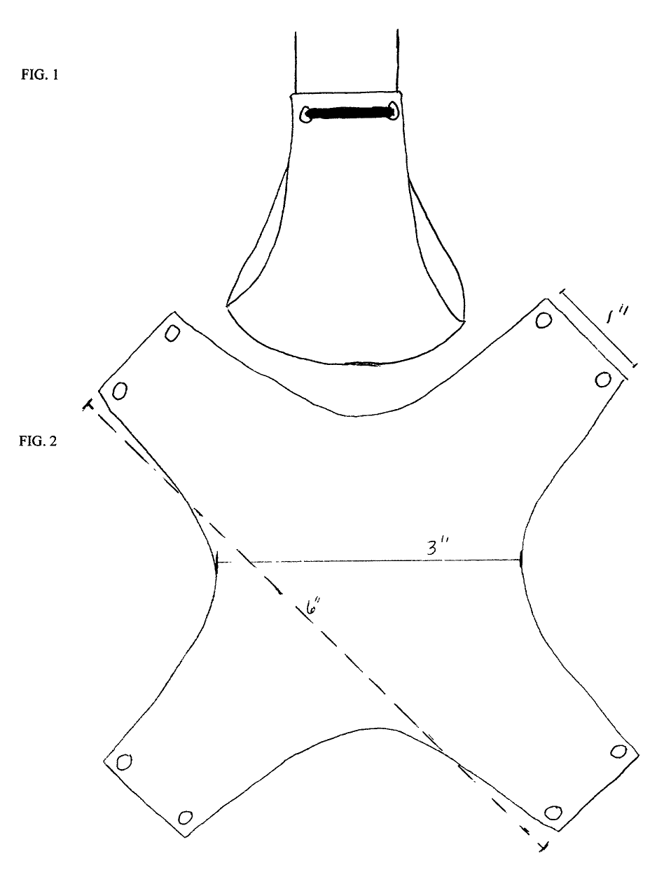

### CROSS-REFERENCE TO RELATED APPLICATIONS

Invention of similar function but made of less effective and more destructive material is Serial Number 75084804.

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

The Walker Moc invention will be utilized most specifically in the field of physical therapy. It will be utilized by people who require the stability of a walker in their homes or in a variety of facilities.

I am a registered physical therapist who has practiced 11 years and have foreseen a need for this product for my clients. We have used tennis balls, cut and slipped onto rear rolling walker legs, for years. These are effective for only a short period of time and then they wear out. Most older or disabled people cannot then safely cut and apply new tennis balls. My estimation of how long common tennis balls last with common wear and tear is two to three months.

I have performed a research project to study how the tennis balls wear vs. The Walker Mocs. Utilizing a rolling walker with 30 lbs. (one-fourth of persons body weight) of evenly distributed weight a set of tennis balls will wear down to rubber base at 300 feet to 400 feet trial over a concrete sidewalk. The Walker Mocs had thinning and roughening at 2,600 feet of concrete but did not wear through. On carpet, the tennis balls begin showing wear at 4,000 to 6,000 feet but the Walker Mocs show no wear signs on carpet no matter the distance and actually they develop a shinier and harder surface when used over carpets and linoleum floors. My findings show that Walker Mocs last 12 times longer than tennis balls over concrete and 30 lbs. pressure upon a walker. Over carpet, tile and linoleum, the Walker Mocs will perform a significantly longer duration.

Several other walker glides are present on the market for rolling walker rear legs. These are all made of plastic and come in varieties of shapes. These work well on carpet, but I have found that once the plastic surface is scratched by traveling over concrete or asphalt one time, these glides scratch linoleum, wood, and some shiny surfaced tile. The facilities that I work have tracks of scratches along the exact paths that people walk multiple times a day and floors I have seen in peoples homes have been ruined by these simple plastic glides.

### BRIEF SUMMARY OF THE INVENTION

The Walker Moc invention is designed as an easily applied walker glide device that will enable rolling walker users to have long lasting performance. The leather Walker Moc will protect all flooring yet is durable enough for all indoor and outdoor surfaces. I expect that it will replace the commonly used but short lasting tennis balls and the damaging plastic glides. The estimated cost of the device will be less than the cost of chronic replacement of tennis balls or the repair/replacement of damaged flooring. Physical Therapy departments and Geriatric Facilities can protect their flooring and ensure long lasting safe and maintenance free walker use.

BRIEF DESCRIPTION OF THE SEVERAL VIEWS OF THE DRAWING

[image]

### DETAILED DESCRIPTION OF THE INVENTION

Walker Mocs are devices made of thick rawhide leather cut by scissors or machine cut in the shape of a fat “X”. The length is 6″ and all sides are symmetrical with distal edges being 1″ wide. Holes are punched into the edges of each leg of the “X” (8 total). A 1 3/4″ diameter leather disc is glued to the inside center of the “X”. Eyelets are riveted into each hole. The device is pulled together in a cupped position as an elastic cord is drawn tight through all the holes. The elastic cord is fastened by a small clasp at a point where all adjacent edges of the “X” are touching each other.

1. What I claim as my invention is the specific design and fastening of leather material for use as a walker glide system
